(19) United States
(12) Patent Application Publication
(10) Pub. No.: US 2023/0011919 A1
(43) Pub. Date: Jan. 12, 2023

(54) ALL SOLID STATE BATTERY

(71) Applicant: TOYOTA JIDOSHA KABUSHIKI KAISHA, Toyota-shi (JP)

(72) Inventors: Shinya SHIOTANI, Nagoya-shi (JP); Takamasa OHTOMO, Miyoshi-shi (JP); Fuminori MIZUNO, Miyoshi-shi (JP)

(73) Assignee: TOYOTA JIDOSHA KABUSHIKI KAISHA, Toyota-shi (JP)

(21) Appl. No.: 17/843,240

(22) Filed: Jun. 17, 2022

(30) Foreign Application Priority Data
Jul. 1, 2021 (JP) 2021-109933

(51) Int. Cl. H01M 50/572; H01M 10/056; H01M 10/0585

(52) U.S. Cl. CPC H01M 50/572; H01M 10/056; H01M 10/0585; H01M 2300/0068; H01M 2300/0082

(57) ABSTRACT

A main object of the present disclosure is to provide an all solid state battery in which occurrence of internal short circuit is inhibited. The present disclosure achieves the object by providing an all solid state battery including, in an order along with a thickness direction, a cathode layer, a solid electrolyte layer and an anode layer; wherein one of the cathode layer and the anode layer is an electrode layer A containing a first polymer electrolyte; the other of the cathode layer and the anode layer is an electrode layer B containing an inorganic solid electrolyte; the solid electrolyte layer contains a second polymer electrolyte; the second polymer electrolyte is a cross-linked polymer to which a polymer component is cross-linked; and in a plan view along with the thickness direction of the all solid state battery, an area of the solid electrolyte layer is larger than an area of the electrode layer A.

### TECHNICAL FIELD

The present disclosure relates to an all solid state battery.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent.

For example, Patent Literature 1 discloses a method for producing an all solid state battery including an anode layer, a solid electrolyte layer and a cathode layer in this order, wherein an area of the cathode layer in a surface direction is smaller than an area of the anode layer in a surface direction. Also, for example, FIG. 2 in Patent Literature 2 discloses an all solid state battery comprising a solid electrolyte layer containing an inorganic solid electrolyte and a polymer electrolyte.

### CITATION LIST

### Patent Literatures

Patent Literature 1: Japanese Patent Application Laid-Open (JP-A) No. 2020-107414
Patent Literature 2: US Patent Application Publication: No. 2016/0149261

### SUMMARY OF DISCLOSURE

### Technical Problem

In an all solid state battery, ions and electrons conduct by utilizing a solid/solid interface, and thus the bonding state of the interface affects greatly to battery properties. Meanwhile, when expansion and contraction (volume change) of active materials occur along with charge and discharge, fine bonding state in the interface may not be maintained but the resistance may increase.

For example, a Si-based active material has been known as an anode active material with high capacity, but the volume change along with charge and discharge is large. In order to inhibit the degrade of battery properties due to expansion and contraction of the anode active material, it is presumed to use a soft polymer electrolyte as the solid electrolyte of the anode layer. Meanwhile, the ion conductivity of the polymer electrolyte is often lower than that of an inorganic solid electrolyte. For this reason, from the view point of improving the battery properties, it is presumed to use the inorganic solid electrolyte in the cathode layer. By using the combination of the polymer electrolyte and the inorganic solid electrolyte, fine battery properties may be obtained while preventing the bonding state of the solid/solid interface in the anode layer from deteriorating. The same effect may be obtained also when the polymer electrolyte is used in the cathode layer and the inorganic solid electrolyte is used in the anode layer, which is the opposite of the above.

Here, in the all solid state battery wherein one of the cathode layer and the anode layer contains an inorganic solid electrolyte, and the other contains a polymer electrolyte, there is a peculiar problem as follows. That is, since the inorganic solid electrolyte is usually harder than the polymer electrolyte, the layer (such as cathode layer) containing the inorganic solid electrolyte becomes a hard layer, and the layer (such as anode layer) containing the polymer electrolyte becomes a soft layer. As a result, deformation (such as stretch and bend) is easily caused in the layer containing the polymer electrolyte during pressing each layer for bonding. When the deformation occurs and the cathode layer contacts with the anode layer, internal short circuit occurs.

The present disclosure has been made in view of the above circumstances and a main object thereof is to provide an all solid state battery in which occurrence of internal short circuit is inhibited.

### Solution to Problem

The present disclosure provides an all solid state battery including, in an order along with a thickness direction, a cathode layer, a solid electrolyte layer and an anode layer; wherein one of the cathode layer and the anode layer is an electrode layer A containing a first polymer electrolyte; the other of the cathode layer and the anode layer is an electrode layer B containing an inorganic solid electrolyte; the solid electrolyte layer contains a second polymer electrolyte; the second polymer electrolyte is a cross-linked polymer to which a polymer component is cross-linked; and in a plan view along with the thickness direction of the all solid state battery, an area of the solid electrolyte layer is larger than an area of the electrode layer A.

According to the present disclosure, even when one of the cathode layer and the anode layer contains the inorganic solid electrolyte and the other contains the polymer electrolyte, occurrence of internal short circuit may be inhibited since the solid electrolyte layer contains a cross-linked polymer electrolyte, and the area of the solid electrolyte layer is larger than the area of the electrode layer A containing the polymer electrolyte.

In the disclosure, in a plan view along with the thickness direction of the all solid state battery, an area of the solid electrolyte layer may be larger than an area of the electrode layer B.

In the disclosure, the electrode layer A may be the anode layer.

In the disclosure, each of the first polymer electrolyte and the second polymer electrolyte may be a dry polymer electrolyte.

In the disclosure, the first polymer electrolyte and the second polymer electrolyte may contain a polyether-based polymer as a polymer component.

In the disclosure, the polyether-based polymer may include a polyethylene oxide structure in a repeating unit.

In the disclosure, the inorganic solid electrolyte may be a sulfide solid electrolyte.

### Advantageous Effects of Disclosure

The all solid state battery in the present disclosure exhibits an effect of inhibiting occurrence of internal short circuit.

### BRIEF DESCRIPTION OF DRAWINGS

FIG. 1 is a schematic cross-sectional view exemplifying the all solid state battery in the present disclosure.

FIG. 2A is a schematic plan view exemplifying the relationship between the solid electrolyte layer and the anode layer, and FIG. 2B is a schematic plan view exemplifying the relationship between the solid electrolyte layer and the cathode layer in the present disclosure.

FIG. 3 is a schematic cross-sectional view exemplifying the all solid state battery in the present disclosure.

FIG. 4 is a flow chart exemplifying the method for producing the all solid state battery in the present disclosure.

FIG. 5 is the results of A.C. impedance measurements for batteries produced in Reference Example 1 and Example 1.

### DESCRIPTION OF EMBODIMENTS

The all solid state battery in the present disclosure is hereinafter explained in details with reference to drawings. Each drawing described as below is a schematic view, and the size and the shape of each portion are appropriately exaggerated in order to be understood easily. Further, in each drawing, hatchings or reference signs are appropriately omitted.

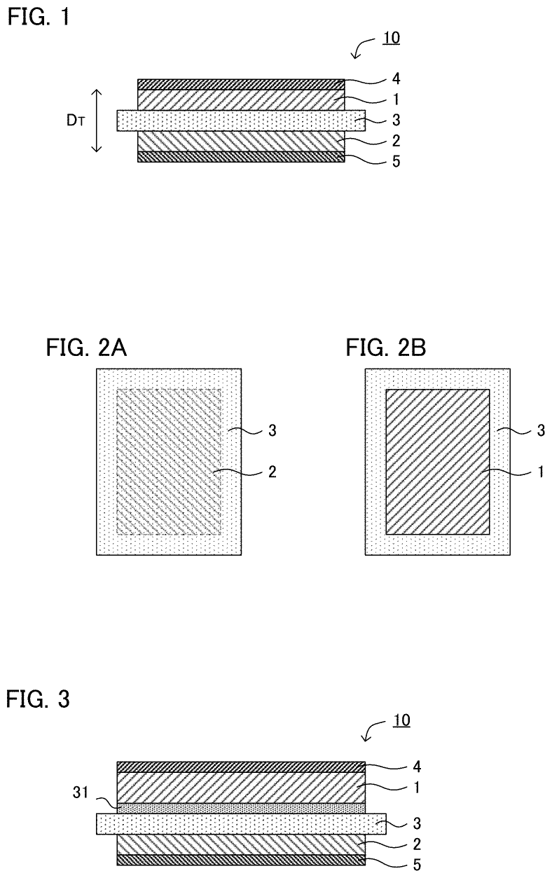

FIG. 1 is a schematic cross-sectional view exemplifying the all solid state battery in the present disclosure. All solid state battery 10 comprises, in an order along with thickness direction DT, cathode layer 1, solid electrolyte layer 3 and anode layer 2. In other words, the all solid state battery 10 comprises the cathode layer 1, the anode layer 2, and the solid electrolyte layer 3 arranged between the cathode layer 1 and the anode layer 2. Further, the all solid state battery 10 includes cathode current collector 4 for collecting electrons from the cathode layer 1, and anode current collector 5 for collecting electrons from the anode layer 2. Also, the anode layer 2 is an electrode layer A containing a first polymer electrolyte, and the cathode layer 1 is an electrode layer B containing an inorganic solid electrolyte. Also, the solid electrolyte layer 3 contains a second polymer electrolyte. The second polymer electrolyte is a cross-linked polymer to which a polymer component is cross-linked.

FIG. 2A is a schematic plan view exemplifying the relationship between the solid electrolyte layer and the anode layer in the present disclosure. As shown in FIG. 2A, in a plan view along with the thickness direction of the all solid state battery, an area of the solid electrolyte layer 3 is larger than an area of the anode layer 2 (electrode layer A). Also, FIG. 2B is a schematic plan view exemplifying the relationship between the solid electrolyte layer and the cathode layer in the present disclosure. As shown in FIG. 2B, in a plan view along with the thickness direction of the all solid state battery, an area of the solid electrolyte layer 3 is larger than an area of the cathode layer 1 (electrode layer B).

According to the present disclosure, even when one of the cathode layer and the anode layer contains the inorganic solid electrolyte and the other contains the polymer electrolyte, occurrence of internal short circuit may be inhibited since the solid electrolyte layer contains a cross-linked polymer electrolyte and the area of the solid electrolyte layer is larger than the area of the electrode layer A containing the polymer electrolyte. As described above, in an all solid state battery wherein one of the cathode layer and the anode layer contains an inorganic solid electrolyte and the other contains a polymer electrolyte, there is a peculiar problem that internal short circuit easily occurs. In contrast, in the present disclosure, the solid electrolyte layer contains a cross-linked polymer electrolyte, and the area of the solid electrolyte layer is large than the area of the electrode layer A containing a polymer electrolyte, and thus the occurrence of the internal short circuit is effectively inhibited. Also, the electrode layer A contains a polymer electrolyte which is soft, and thus the degrade of battery properties due to expansion and contraction of the active material is inhibited. Further, the electrode layer B contains an inorganic solid electrolyte with high ion conductivity, and thus an all solid state battery with fine battery properties is obtained.

1. Electrode Layer A

One of the cathode layer and the anode layer is an electrode layer A containing a first polymer electrolyte. The first polymer electrolyte contains at least a polymer component. Examples of the polymer component may include a polyether-based polymer, a polyester-based polymer, a polyamine-based polymer, and a polysulfide-based polymer, and the polyether-based polymer is preferable among them. The reason therefor is because it has high ion conductivity, and is excellent in mechanical characteristics such as Young's modulus and breaking strength.

The polyether-based polymer includes a polyether structure in a repeating unit. Also, the polyether-based polymer preferably includes the polyether structure in a main chain of the repeating unit. Examples of the polyether structure may include a polyethylene oxide (PEO) structure, and a polypropylene oxide (PPO) structure. The polyether-based polymer preferably includes the PEO structure as a main repeating unit. The proportion of the PEO structure with respect to all the repeating units in the polyether-based polymer is, for example, 50 mol % or more, may be 70 mol % or more, and may be 90 mol % or more. Also, the polyether-based polymer may be, for example, a homopolymer or a copolymer of an epoxy compound (such as ethylene oxide and propylene oxide).

The polymer component may include an ion conductive unit as shown below. Examples of the ion conductive unit may include polyethylene oxide, polypropylene oxide, ester polymethacrylate, ester polyacrylate, polydimethyl siloxane, polyacrylate, polymethacrylate, polyethylene vinyl acetate, polyimide, polyamine, polyamide, polyalkyl carbonate, polynitrile, polyphosphazen, polyolefin, and polydiene.

The weight average molecular weight (Mw) of the polymer component is not particularly limited, but for example, it is 1,000,000 or more and 10,000,000 or less. Mw may be obtained by gel permeation chromatography (GPC). Also, the glass transfer temperature (Tg) of the polymer component is, for example, 60° C. or less, may be 40° C. or less, and may be 25° C. or less. Also, the first polymer electrolyte may contain just one kind of the polymer component, and may contain two kinds or more thereof. Further, the first polymer electrolyte may be a cross-linked polymer electrolyte to which the polymer component is cross-linked, and may be a non-cross-linked polymer to which the polymer component is not cross-linked.

The first polymer electrolyte may be a dry polymer electrolyte and may be a gel electrolyte. The dry polymer electrolyte refers to an electrolyte of which content of the solvent component is 5 weight % or less. The content of the solvent component may be 3 weight % or less, and may be 1 weight % or less. In particular, it is preferable that the electrode layer A contains the dry polymer electrolyte, and the electrode layer B contains a sulfide solid electrolyte. The reason therefor is to inhibit the deterioration of the sulfide solid electrolyte due to the solvent.

The dry polymer electrolyte may contain a supporting electrolyte. Examples of the supporting electrolyte may include an inorganic lithium salt such as LiPF₆, LiBF₄, LiClO₄ and LiAsF₆, and an organic lithium salt such as LiCF₃SO₃, LiN (CF₃SO₂)₂, LiN (C₂F₅SO₂)₂, LiN (FSO₂)₂ and LiC(CF₃SO₂)₃. There are no particular limitations on the proportion of the supporting electrolyte with respect to the dry polymer electrolyte. For example, when the dry polymer electrolyte includes an EO unit (C₂H₅O unit), the EO unit with respect to 1 part by mol of the supporting electrolyte is, for example, 5 parts by mol or more, may be 10 parts by mol or more, and may be 15 parts by mol or more. Meanwhile, the EO unit with respect to 1 part by mol of the supporting electrolyte is, for example, 40 parts by mol or less and may be 30 parts by mol or less.

The gel electrolyte usually contains a liquid electrolyte component in addition to the polymer component. The liquid electrolyte component contains a supporting electrolyte and a solvent. The supporting electrolyte is as described above. Examples of the solvent may include carbonate. Examples of the carbonate may include a cyclic ester (cyclic carbonate) such as ethylene carbonate (EC), propylene carbonate (PC) and butylene carbonate (BC); and a chain ester (chain carbonate) such as dimethyl carbonate (DMC), diethyl carbonate (DEC), and ethyl methyl carbonate (EMC). Also, examples of the solvent may include acetates such as methyl acetate and ethyl acetate, and ether such as 2-methyltetrahydrofran. Further, examples of the solvent may include γ-butyrolactone, sulfolane, N-methyl pyrrolidone (NMP), and 1,3-dimethyl-2-imidazolidinone (DMI). Also, the solvent may be water.

The electrode layer A preferably contains the first polymer electrolyte as a main component of the solid electrolyte. In the electrode layer A, the proportion of the first polymer electrolyte with respect to all the solid electrolyte is, for example, 50 volume % or more, may be 70 volume % or more, and may be 90 volume % or more. The electrode layer A may contain just the first polymer electrolyte as the solid electrolyte.

The proportion of the first polymer electrolyte in the electrode layer A is, for example, 20 volume % or more, may be 30 volume % or more, and may be 40 volume % or more. Meanwhile, the proportion of the first polymer electrolyte in the electrode layer A is, for example, 70 volume % or less, and may be 60 volume % or less.

The electrode layer A may be an anode layer. The anode layer contains an anode active material. Examples of the anode active material may include a metal active material such as Si, Sn and Li, a carbon active material such as graphite, and an oxide active material such as lithium titanate. Also, the anode active material may be a Si-based active material including at least Si. The volume change of the Si-based active material along with charge and discharge is large, and thus the battery properties may be easily degraded due to the expansion and contraction. In contrast, for example, by using the electrode layer A containing the first polymer electrolyte, which is soft, as the anode layer, the degrade of battery properties due to the expansion and contraction may be inhibited. Examples of the Si-based active material may include a simple substance Si, a Si alloy and a Si ixide. The Si alloy preferably contains a Si element as a main component. In the Si alloy, the proportion of the Si is, for example, 50 at % or more, may be 70 at % or more, and may be 90 at % or more.

Also, the total volume expansion rate of the anode active material due to charge may be 13% or more. Here, the total volume expansion rate of graphite due to charge is 13% (Simon Schweidler et al., “Volume Changes of Graphite Anodes Revisited: A Combined Operando X-ray Diffraction and In Situ Pressure Analysis Study”, J. Phys. Chem. C 2018, 122, 16, 8829-8835). In other words, the total volume expansion rate of the anode active material due to charge in the present disclosure may be equivalent to that of graphite. The total volume expansion rate of the anode active material due to charge may be 100% or more and may be 200% or more. The total volume expansion rate due to charge may be obtained by a space-group-independent evaluation as described in Simon Schweidler et al.

Examples of the shape of the anode active material may include a granular shape. The average particle size (D₅₀) of the anode active material is, for example, 10 nm or more, and may be 100 nm or more. Meanwhile, the average particle size (D₅₀) of the anode active material is, for example, 50 μm or less, and may be 20 μm or less. The average particle size (D₅₀) may be calculated from, for example, a measurement with a laser diffraction particle distribution meter or a scanning electron microscope (SEM).

The proportion of the anode active material in the anode layer is, for example, 20 weight % or more, may be 40 weight % or more and may be 60 weight % or more. Meanwhile, the proportion of the anode active material is, for example, 80 weight % or less.

The anode layer may contain a conductive material. Addition of the conductive material improves the electron conductivity of the anode layer. Examples of the conductive material may include a particulate carbon material such as acetylene black (AB) and Ketjen black (KB), and a fiber carbon material such as carbon fiber, carbon nanotube (CNT), and carbon nanofiber (CNF). Also, the anode layer may contain a binder. Addition of the binder strongly bonds the constituent materials of the anode layer. Examples of the binder may include a fluoride-based binder, a polyimide-based binder and a rubber-based binder. Also, the thickness of the anode layer is, for example, 0.1 μm or more and 1000 μm or less.

The electrode layer A may be a cathode layer. The cathode layer contains a cathode active material. Examples of the cathode active material may include an oxide active material. Examples of the oxide active material may include a rock salt bed type active material such as LiCoO₂ and LiNi_{1/3}Co_{1/3}Mn_{1/3}O₂; a spinel type active material such as LiMn₂O₄ and Li₄Ti₅O₁₂; and an olivine type active material such as LiFePO₄.

A protective layer containing Li-ion conductive oxide may be formed on the surface of the oxide active material. The reason therefor is to inhibit the reaction of the oxide active material and the solid electrolyte. Examples of the Li-ion conductive oxide may include LiNbO₃. The thickness of the protective layer is, for example, 1 nm or more and 30 nm or less. Also, as the cathode active material, for example, Li₂S can be used.

Examples of the shape of the cathode active material may include a granular shape. The average particle size (D₅₀) of the cathode active material is not particularly limited, and for example, it is 10 nm or more, and may be 100 nm or more. Meanwhile, the average particle size (D₅₀) of the cathode active material is, for example, 50 μm or less, and may be 20 μm or less.

The cathode layer may further contain at least one of a conductive material and a binder. The conductive material and the binder are in the same contents as those described above; thus, the descriptions herein are omitted. Also, the thickness of the cathode layer is, for example, 0.1 μm or more and 1000 μm or less.

2. Electrode Layer B

The other of the cathode layer and the anode layer is an electrode layer B containing an inorganic solid electrolyte. Examples of the inorganic solid electrolyte may include a sulfide solid electrolyte, an oxide solid electrolyte and a halide solid electrolyte. Also, the inorganic solid electrolyte may be glass (amorphous), may be glass ceramic, and may be a crystal. Glass may be obtained by, for example, amorphizing a raw material. Glass ceramic may be obtained by, for example, performing a heat treatment to glass. Crystal may be obtained by, for example, heating a raw material.

It is preferable that the sulfide solid electrolyte contains, for example, Li, A (A is at least one kind of P, As, Sb, Si, Ge, Sn, B, Al, Ga, and In), and S. The sulfide solid electrolyte may further contain at least one of O (oxygen) and halogen. Examples of the halogen may include F, Cl, Br, and I. The sulfide solid electrolyte may contain just one kind of the halogen, and may contain two kinds or more of the halogen. Also, when the sulfide solid electrolyte contains an anion element (such as O and halogen) other than S, it is preferable that the molar ratio of S is the most with respect to all the anion elements.

The sulfide solid electrolyte preferably includes an anion structure of an ortho composition (PS₄³⁻ structure, sis₄⁴⁻ structure, GeS₄⁴⁻ structure, AlS₃³⁻ structure, and BS₄³⁻ structure) as the main component of the anion structure. The reason therefor is that chemical stability is high. The proportion of the anion structure of the ortho composition with respect to all the anion structures in the sulfide solid electrolyte is, for example, 50 mol % or more, may be 60 mol % or more and may be 70 mol % or more.

The sulfide solid electrolyte may include a crystal phase with ion conductivity. Examples of the crystal phase may include a Thio-LISICON type crystal phase, a LGPS type crystal phase, and an argyrodite type crystal phase.

Also, it is preferable that the oxide solid electrolyte contains, for example, Li, Z (Z is at least one kind of Nb, B, Al, Si, P, Ti, Zr, Mo, W and S), and O. Specific examples of the oxide solid electrolyte may include a garnet type solid electrolyte such as Li₇La₃Zr₂O₁₂; a Perovskite type solid electrolyte such as (Li, La)TiO₃; a nasicon type solid electrolyte such as Li(Al,Ti) (PO₄)₃; a Li—P—O-based solid electrolyte such as Li₃PO₄; and a Li—B—O-based solid electrolyte such as Li₃BO₃. Also, when the oxide solid electrolyte contains an anion element (such as S and halogen) other than O, it is preferable that the molar ratio of O is the most with respect to all the anion elements.

The halide solid electrolyte is an electrolyte containing halogen (X). Examples of the halogen may include F, Cl, Br, and I. Examples of the halide solid electrolyte may include Li₃YX₆ (X is at least one kind of F, Cl, Br and I). Also, when the halide solid electrolyte contains an anion element (such as S and O) other than halogen, it is preferable that the molar ratio of halogen is the most with respect to all the anion elements.

Examples of the shape of the inorganic solid electrolyte may include a granular shape. The average particle size (D₅₀) of the inorganic solid electrolyte is not particularly limited, and for example, it is 10 nm or more, and may be 100 nm or more. Meanwhile, the average particle size (D₅₀) of the inorganic solid electrolyte is, for example, 50 μm or less, and may be 20 μm or less.

The electrode layer B preferably contains an inorganic solid electrolyte as a main component of the solid electrolyte. The proportion of the inorganic solid electrolyte with respect to all the solid electrolyte in the electrode layer B is, for example, 50 volume % or more, may be 70 volume % or more, and may be 90 volume % or more. The electrode layer B may contain just the inorganic solid electrolyte as the solid electrolyte.

The proportion of the inorganic solid electrolyte in the electrode layer B is, for example, 10 volume % or more, and may be 20 volume % or more. Meanwhile, the proportion of the inorganic solid electrolyte in the electrode layer B is, for example, 60 volume % or less, and may be 50 volume % or less.

The electrode layer B may be a cathode layer, and may be an anode layer. The cathode active material, the anode active material, the conductive material, the binder and other matters are in the same contents as those described in “1. Electrode layer A” above; thus, the descriptions herein are omitted.

3. Solid Electrolyte Layer

The solid electrolyte layer in the present disclosure is arranged between the cathode layer and the anode layer, and contains at least a second polymer electrolyte as a solid electrolyte.

The second polymer electrolyte is a cross-linked polymer to which a polymer component is cross-linked. The second polymer electrolyte is in the same contents as the first polymer electrolyte described in “1. Electrode layer A”, except that the polymer component is cross-linked. Examples of the polymerization initiator for cross-linking the polymer component may include a peroxide such as benzoyl peroxide, di-tert-butyl peroxide, tert-butyl benzoyl peroxide, tert-butyl peroxy octoate, and cumene hydroxy peroxide; and an azo compound such as azo bisisobutyro nitrile. The second polymer electrolyte in the solid electrolyte layer and the first polymer electrolyte in the electrode layer A may or may not have the same composition.

The solid electrolyte layer is preferably independent. “Independent” means that the layer is capable of maintaining its shape without other supporting body. For example, when an intended solid electrolyte layer is arranged on a substrate, and the solid electrolyte layer is peeled off from the substrate, if the solid electrolyte layer maintains its shape, it can be said that the layer is “independent”.

The solid electrolyte layer preferably contains the second polymer electrolyte as a main component of the solid electrolyte. The proportion of the second polymer electrolyte with respect to all the solid electrolytes in the solid electrolyte layer is, for example, 50 volume % or more, may be 70 volume % or more, and may be 90 volume % or more. The solid electrolyte layer may contain just the second polymer electrolyte as the solid electrolyte. The thickness of the solid electrolyte layer is, for example, 0.1 μm or more and 1000 μm or less.

Also, in the present disclosure, in a plan view along with the thickness direction of the all solid state battery, an area of the solid electrolyte layer is usually larger than an area of the electrode layer A. FIG. 2A is a schematic plan view exemplifying the relationship between the solid electrolyte layer and the anode layer in the present disclosure. In specific, it is a schematic plan view of the anode layer 2 (electrode layer A) and the solid electrolyte layer 3 in FIG. 1 observed from the upper side towards the lower side of FIG. 1. In FIG. 2A, the solid electrolyte layer 3 is arranged to cover the entire periphery of the anode layer 2 (electrode layer A), and the area of the solid electrolyte layer 3 is larger than the area of the anode layer 2 (electrode layer A).

Also, in the present disclosure, in a plan view along with the thickness direction of the all solid state battery, an area of the solid electrolyte layer may be larger than an area of the electrode layer B. FIG. 2B is a schematic plan view exemplifying the relationship between the solid electrolyte layer and the cathode layer in the present disclosure. In specific, it is a schematic plan view of the cathode layer 1 (electrode layer B) and the solid electrolyte layer 3 in FIG. 1 observed from the upper side towards the lower side of FIG. 1. In FIG. 2B, the solid electrolyte layer 3 is arranged to cover the entire periphery of the cathode layer 1 (electrode layer B), and the area of the solid electrolyte layer 3 is larger than the area of the cathode layer 1 (electrode layer B).

Here, S₁ designates the area of the electrode layer A, S₂ designates the area of the electrode layer B, and S₃ designates the area of the solid electrolyte layer. The rate of S₃ with respect to S₁, which is S₃/S₁ is, for example, 1.01 or more, may be 1.03 or more, may be 1.05 or more, may be 1.1 or more and may be 1.2 or more. If S₃/S₁ is small, there is a possibility that the occurrence of internal short circuit may not be sufficiently inhibited. Meanwhile, there are no particular limitations on the upper limit of the rate of S₃ with respect to S₁, which is S₃/S₁, but if S₃/S₁ is large, there is a possibility that the volume energy density may be degraded. Also, the rate of S₃ with respect to S₂, which is S₃/S₂ is, for example, 1.00 or more, may be 1.01 or more, may be 1.03 or more, may be 1.05 or more, may be 1.1 or more and may be 1.2 or more. Meanwhile, the upper limit of the rate of S₃ with respect to S₂, which is S₃/S₂ is not particularly limited.

The area (S₁) of the electrode layer A may be larger than the area (S₂) of the electrode layer B. In this case, the rate of S₁ with respect to S₂, which is Si/S₂ is, for example, 1.01 or more, may be 1.03 or more, and may be 1.05 or more. Meanwhile, the area (S₂) of the electrode layer B may be larger than the area (S₁) of the electrode layer A. In this case, the rate of S₂ with respect to S₁, which is S₂/S₁ is, for example, 1.01 or more, may be 1.03 or more, and may be 1.05 or more. The area (S₁) of the electrode layer A may be the same as the area (S₂) of the electrode layer B. In this case, both of S₁/S₂ and S₂/S₁ are usually less than 1.01.

Also, all solid state battery 10 shown in FIG. 3 includes cathode layer 1 as an electrode layer A, and include anode layer 2 as an electrode layer B. Solid electrolyte layer 31 for bonding that contains an inorganic solid electrolyte may be arranged between the cathode layer (electrode layer A) and the solid electrolyte layer 3. In the later described Example, the solid electrolyte layer 31 for bonding is transferred to the cathode layer 1 (electrode layer A), and then the cathode layer 1 (electrode layer A) is densified. Further, the solid electrolyte layer 31 for bonding and the solid electrolyte layer 3 are adhered. The solid electrolyte layer 31 for bonding preferably contains a sulfide solid electrolyte as the inorganic solid electrolyte. Also, in a plan view along with the thickness direction of the all solid state battery, the solid electrolyte layer 31 for bonding preferably has the same area as that of the cathode layer 1 (electrode layer A).

4. Other Constitutions

The all solid state battery in the present disclosure usually comprises a cathode current collector for collecting electrons from the cathode layer and an anode current collector for collecting electrons from the anode layer. Examples of the material for the cathode current collector may include SUS, aluminum, nickel, and carbon. Examples of the shape of the cathode current collector may include a foil shape. Meanwhile, examples of the material for the anode current collector may include SUS, copper, nickel, and carbon. Examples of the shape of the anode current collector may include a foil shape.

The all solid state battery in the present disclosure may include a restraining jig that applies a restraining pressure along with the thickness direction of the cathode layer, the solid electrolyte layer and the anode layer. Excellent ion conducting path and electron conducting path may be formed by applying the restraining pressure. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

5. All Solid State Battery

The all solid state battery in the present disclosure comprises a power generating unit including a cathode layer, a solid electrolyte layer and an anode layer. The all solid state battery may include just one of the power generating unit, and may include two or more thereof. When the all solid state battery comprises a plurality of the power generating unit, they may be connected in parallel and may be connected in series. Also, the all solid state battery includes an outer package for storing the cathode layer, the solid electrolyte layer, and the anode layer. Examples of the outer package may include a laminate type outer package and a can type outer package.

The all solid state battery in the present disclosure is typically an all solid lithium ion secondary battery. The application of the all solid state battery is not particularly limited, and examples thereof may include a power source for vehicles such as hybrid electric vehicles (HEV), battery electric vehicles (BEV), fuel cell electric vehicles and diesel powered automobiles. In particular, it is preferably used as a power source for driving hybrid electric vehicles and battery electric vehicles. Also, the all solid state battery in the present disclosure may be used as a power source for moving bodies other than vehicles (such as rail road transportation, vessel and airplane), and may be used as a power source for electronic products such as information processing equipment.

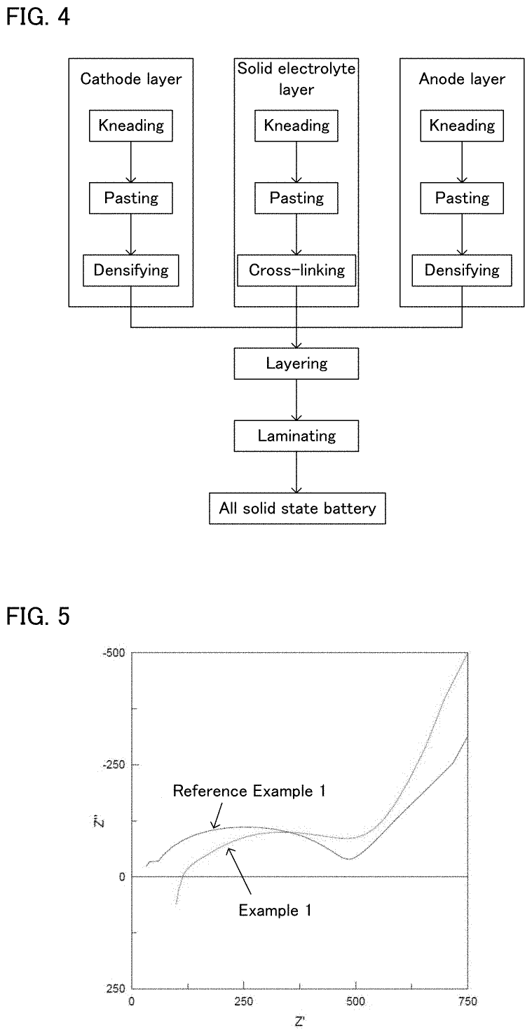

The method for producing the all solid state battery in the present disclosure is not particularly limited. FIG. 4 is a flow chart exemplifying a method for producing the all solid state battery in the present disclosure. In FIG. 4, first, constituent materials of the cathode layer and a dispersion medium are mixed, and then kneaded to produce slurry. The obtained slurry is pasted on the cathode current collector, and then dried to remove the dispersion medium, and thereby a coating layer is formed. After that, a pressing treatment is performed to the coating layer, the coating layer is densified, and the cathode layer is formed. Thereby, a cathode structure body including the cathode current collector and the cathode layer is produced. Also, an anode structure body including an anode current collector and an anode layer is produced in the same manner.

Next, constituent materials of the solid electrolyte layer, a polymerization initiator and a solvent are mixed and kneaded to produce a homogeneous polymer electrolyte solution. The obtained slurry is pasted on a substrate, and then dried to remove the dispersion medium, and the polymerization reaction is conducted at the same time. Thereby, a solid electrolyte layer containing a cross-linked polymer electrolyte to which a polymer component is cross-linked, is produced on the substrate.

Next, the cathode structure body is arranged on one surface side of the solid electrolyte layer, and the anode structure body is arranged on the other surface side of the solid electrolyte layer. Thereby, a layered body including, in an order along with a thickness direction, a cathode current collector, a cathode layer, a solid electrolyte layer, an anode layer, and an anode current collector, is produced. On this occasion, since the solid electrolyte layer contains the second polymer electrolyte (cross-linked polymer to which a polymer component is cross-linked), pressing at high pressure is not necessary. Next, a cathode terminal and an anode terminal are installed to the obtained layered body and the product is laminated and sealed by an outer package. Thereby, an all solid state battery is obtained.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Comparative Example 1

<Production of Polymer Electrolyte Solution>

Polyethylene oxide (PEO; Mw of approximately 4,000,000) and lithium bis(trifluoromethanesulfonyl)amide (Li-TFSI) were weighed so as to be EO unit: Li=20:1 in the molar ratio. These were dissolved in acetonitrile to obtain a polymer electrolyte solution.

<Production of Sulfide Solid Electrolyte>

As starting raw materials, Li₂S, P₂S₅ and LiI were prepared. Next, Li₂S and P₂S₅ were weighed so as to be 75Li₂S.25P₂S₅ in the molar ratio (Li₃PS₄, ortho composition). Next, LiI was weighed so that the ratio of LiI became 15 mol %. The weighed starting raw materials were mixed by an agate mortar for 5 minutes, and the mixture was put into a container of a planetary ball mill, dehydrated heptane was put thereinto, ZrO₂ ball (φ=5 mm) was further put thereinto, and the container was completely sealed. This container was installed to a planetary ball milling machine (P7 from Fritsch), and mechanical milling (revolution speed: 500 rpm) was conducted for 40 hours. After that, the product was dried at 100° C. to remove heptane, and thereby a sulfide glass was obtained. The obtained sulfide glass was put into a glass tube, and a heat treatment was performed at 190° C. for 10 hours, and thereby a sulfide solid electrolyte that was glass ceramic was obtained.

<Production of Cathode Structure Body>

Following materials were prepared and mixed.
Nickel-cobalt lithium aluminate (cathode active material)
Produced sulfide solid electrolyte (solid electrolyte)
Vapor grown carbon fiber (conductive material)
Butyl butyrate solution containing 5 weight % of polyvinylidene fluoride-based binder (binder solution)
Butyl butyrate (dispersion medium)

Incidentally, the volume ratio of the cathode active material and the sulfide solid electrolyte was 75:25.

The obtained mixture was agitated by an ultrasonic dispersion device for 30 seconds. After that, the mixture was shaken for 30 minutes to obtain a cathode slurry. The obtained cathode slurry was pasted on an Al foil (cathode current collector) by a blade method using an applicator. The product was dried naturally, and then dried for 30 minutes on a hot plate at 100° C. Thereby, a cathode structure body including a cathode current collector and a cathode layer was obtained.

<Production of Anode Structure Body>

Following materials were prepared and mixed.
Silicon particle (anode active material)
Vapor grown carbon fiber (conductive material)
Butyl butyrate solution containing 5 weight % of polyvinylidene fluoride-based binder (binder solution)
Butyl butyrate (dispersion medium)

The obtained mixture was agitated by an ultrasonic dispersion device for 30 seconds. After that, the mixture was shaken for 30 minutes to obtain an anode slurry. The obtained anode slurry was pasted on a Ni foil (anode current collector) by a blade method using an applicator. The product was dried naturally, and then dried for 30 minutes on a hot plate at 100° C. Thereby, a precursor layer was formed on the anode current collector. After that, a polymer electrolyte solution was pasted on the precursor layer by a blade method using an applicator. On this occasion, the gap of the blade was adjusted so that the volume ratio of the anode active material and the polymer electrolyte became 50:50. The product was dried naturally, and then dried for 30 minutes on a hot plate at 100° C. Thereby, an anode structure body including an anode current collector and an anode layer was obtained.

<Production of Solid Electrolyte Layer>

Following materials were prepared and mixed.
Produced sulfide solid electrolyte (solid electrolyte)
Heptane solution containing 5 weight % of polyvinylidene fluoride-based binder (binder solution)
Heptane (dispersion medium)

The obtained mixture was agitated by an ultrasonic dispersion device for 30 seconds. After that, the mixture was shaken for 30 minutes to obtain a slurry for a solid electrolyte layer. The obtained slurry for a solid electrolyte layer was pasted on an Al foil (substrate for transfer) by a blade method using an applicator. The product was dried naturally, and then dried for 30 minutes on a hot plate at 100° C. Thereby, a solid electrolyte layer (5 μm thick) was formed on the Al foil.

<Production of all Solid State Battery>

First, the cathode layer in the cathode structure body, and the solid electrolyte layer were arranged to face to each other. A roll-pressing treatment was conducted to this layered body in the conditions of 165° C. and 100 kN. Thereby, the solid electrolyte layer was transferred to the cathode layer, and the cathode layer was densified. After that, the Al foil was peeled off from the solid electrolyte layer to obtain a cathode structure body including the solid electrolyte layer.

Next, the anode layer in the anode structure body, and the solid electrolyte layer were arranged to face to each other. A roll-pressing treatment was conducted to this layered body in the conditions of room temperature and 60 kN. Thereby, the solid electrolyte layer was transferred to the anode layer, and the anode layer was densified. After that, the Al foil was peeled off from the solid electrolyte layer to obtain an anode structure body including the solid electrolyte layer.

Next, the cathode structure body including the solid electrolyte layer was punched out into a size of φ11.28 (1 cm²). Also, the anode structure body including the solid electrolyte layer was punched out into a size of φ11.74 (1.08 cm²). The solid electrolyte layer punched out into the size of φ11.74 (1.08 cm²) was arranged between the solid electrolyte layer in the punched-out cathode structure body, and the solid electrolyte layer in the punched-out anode structure body, and then a roll-pressing treatment was conducted to the product in the conditions of 100° C. and 20 kN to bond each layer. A cathode terminal and an anode terminal were installed to the bonded power generating unit, and further sealed with a laminate film to obtain an all solid state battery.

### Reference Example 1

First, in the same manner as in Comparative Example 1, a solid electrolyte layer, a cathode structure body including the solid electrolyte layer, and an anode structure body including the solid electrolyte were prepared.

Next, the cathode structure body including the solid electrolyte layer was punched out into a size of φ11.74 (1.08 cm²). Also, the anode structure body including the solid electrolyte layer was punched out into a size of φ11.28 (1 cm²). The solid electrolyte layer punched out into the size of φ11.74 (1.08 cm²) was arranged between the solid electrolyte layer in the punched-out cathode structure body, and the solid electrolyte layer in the punched-out anode structure body, and then a roll-pressing treatment was conducted to the product in the conditions of 100° C. and 20 kN to bond each layer. A cathode terminal and an anode terminal were installed to the bonded power generating unit, and further sealed with a laminate film to obtain an all solid state battery.

### Example 1

First, in the same manner as in Comparative Example 1, a polymer electrolyte solution, a solid electrolyte layer, a cathode structure body, and an anode structure body were prepared.

<Production of all Solid State Battery>

The cathode layer in the cathode structure body, and the solid electrolyte layer were arranged to face to each other. After that, in the same manner as in Comparative Example 1, a cathode structure body including the solid electrolyte layer was obtained.

Next, PET films were arranged on both surfaces of the anode structure body, and a roll-pressing treatment was conducted to the product in the conditions of room temperature and 60 kN. Thereby, an anode structure body (not including a solid electrolyte layer) including an anode layer densified was obtained.

Next, benzoyl peroxide (BPO, radical polymerization initiator) was mixed with the polymer electrolyte solution so as to be 10 weight % with respect to the mixture of PEO and Li-TFSI, and the mixture was agitated to be a homogeneous solution. The produced solution was pasted on a PET film by a blade method using an applicator. The product was dried naturally, and then dried on a hot plate at 100° C. Thereby, a solid electrolyte layer (50 μm thick) was obtained. The obtained solid electrolyte layer was independent.

Next, the cathode structure body including the solid electrolyte layer was punched out into a size of φ11.74 (1.08 cm²). Also, the anode structure body not including a solid electrolyte layer was punched out into a size of φ11.74 (1.08 cm²). The solid electrolyte layer punched out into the size of φ13 (1.33 cm²) was arranged between the solid electrolyte layer in the punched-out cathode structure body, and the solid electrolyte layer in the punched-out anode structure body. After that, in a different manner as in Reference Example 1, a cathode terminal and an anode terminal were installed to the power generating unit without conducting a roll-pressing treatment. Further, the product was sealed with a laminate film to obtain an all solid state battery.

[Evaluation]

Open circuit voltage (OCV) of the all solid state batteries produced in Comparative Example 1, Reference Example 1, and Example 1 was respectively measured to confirm if short circuit occurred or not. The results are shown in Table 1.

TABLE 1

| | Area of | Area of | Area of | | |
|---|---|---|---|---|---|
| | cathode | solid | anode | | |
| | layer | electrolyte | layer | OCV | Short |
| | (cm²) | layer (cm²) | (cm²) | (V) | circuit |
| Comparative | 1 | 1.08 | 1.08 | 0 | Occurred |
| Example 1 | | | | | |
| Reference | 1.08 | 1.08 | 1 | 0.34 | Not |
| Example 1 | | | | | occurred |
| Example 1 | 1.08 | 1.33 | 1.08 | 0.34 | Not |
| | | | | | occurred |

As shown in Table 1, OCV was 0 V in Comparative Example 1, which means that internal short circuit occurred. On the other hand, OCV was larger than 0 in Reference Example 1 and Example 1, and it was confirmed that internal short circuit did not occur. In this manner, in the all solid state battery containing the inorganic solid electrolyte and the polymer electrolyte, it was confirmed that the occurrence of internal short circuit was inhibited when the area of the anode layer was smaller than the area of the solid electrolyte layer.

Also, an impedance measurement was conducted to the all solid state batteries (SOC=0%) produced in Reference Example 1 and Example 1. The results are shown in FIG. 5. As shown in FIG. 5, D.C. resistance of Example 1 was larger than that of Reference Example 1. This is presumably because the ion conductivity of the solid electrolyte layer using the polymer electrolyte was lower than the ion conductivity of the solid electrolyte layer using the inorganic solid electrolyte. Meanwhile, when focusing on the reaction resistance at the circular arc end, equivalent results were obtained in Reference Example 1 and Example 1. In Reference Example 1, pressure was applied to bond each layer, but the pressure was not applied in Example 1. Regardless of the fact, remarkable effect was confirmed that the equivalent results were obtained in Reference Example 1 and Example 1. The reason therefor is presumably because the interlayer peel-off between the anode layer and the solid electrolyte layer was restrained in Example 1.

### REFERENCE SIGNS LIST

1 cathode layer
2 cathode current collector
3 solid electrolyte layer
4 anode layer
5 anode current collector
10 all solid state battery

What is claimed is:

1. An all solid state battery comprising, in an order along with a thickness direction, a cathode layer, a solid electrolyte layer and an anode layer; wherein
one of the cathode layer and the anode layer is an electrode layer A containing a first polymer electrolyte;
the other of the cathode layer and the anode layer is an electrode layer B containing an inorganic solid electrolyte;
the solid electrolyte layer contains a second polymer electrolyte;
the second polymer electrolyte is a cross-linked polymer to which a polymer component is cross-linked; and
in a plan view along with the thickness direction of the all solid state battery, an area of the solid electrolyte layer is larger than an area of the electrode layer A.

2. The all solid state battery according to claim 1, wherein, in a plan view along with the thickness direction of the all solid state battery, the area of the solid electrolyte layer is larger than an area of the electrode layer B.

3. The all solid state battery according to claim 1, wherein the electrode layer A is the anode layer.

4. The all solid state battery according to claim 1, wherein each of the first polymer electrolyte and the second polymer electrolyte is a dry polymer electrolyte.

5. The all solid state battery according to claim 1, wherein the first polymer electrolyte and the second polymer electrolyte contain a polyether-based polymer as a polymer component.

6. The all solid state battery according claim 5, wherein the polyether-based polymer includes a polyethylene oxide structure in a repeating unit.

7. The all solid state battery according to claim 1, wherein the inorganic solid electrolyte is a sulfide solid electrolyte.
